(19) United States
(12) Patent Application Publication
(10) Pub. No.: US 2013/0028718 A1
(43) Pub. Date: Jan. 31, 2013

(54) STRUT, A GAS TURBINE ENGINE FRAME COMPRISING THE STRUT AND A GAS TURBINE ENGINE COMPRISING THE FRAME

(71) Applicants: Linda Ström, Trollhattan (SE); Jonas Lindskog, Svanesund (SE); Per Widström, Grastorp (SE)

(72) Inventors: Linda Ström, Trollhattan (SE); Jonas Lindskog, Svanesund (SE); Per Widström, Grastorp (SE)

(21) Appl. No.: 13/641,134

(22) PCT Filed: Apr. 16, 2010
(86) PCT No.: PCT/SE10/00098

§ 371 Date: Oct. 15, 2012

(30) Foreign Application Priority Data
Apr. 15, 2010 (EP) 10160069.0

(51) Int. Cl. F02C 7/00

(52) U.S. Cl. 415/182.1

(57) ABSTRACT

A strut is provided for being arranged between an annular inner structural casing and an annular outer structural casing in a gas turbine engine frame for carrying loads between the inner and outer structural casing during operation. The strut includes a first tube, which is configured to house a service line or pipe between the inner and outer structural casing. The strut includes a second tube, which is configured to house a fastening element for rigidly connecting the inner and outer structural casing. The first and second tube are arranged in a side-by-side relationship and rigidly attached to each other.

### BACKGROUND AND SUMMARY

The present invention relates to a strut for being arranged between an annular inner structural casing and an annular outer structural casing in a gas turbine engine frame for carrying loads between the inner and outer structural casing during operation, wherein the strut comprises a first tube, which is configured to house a service line or pipe between the inner and outer structural casing. The invention is further directed to a gas turbine engine frame comprising the strut and a gas turbine engine comprising the frame.

The invention will below be described applied in a intermediate gas turbine engine component (also called structure or frame). The intermediate gas turbine engine component is adapted to transfer loads and form support for bearings. The invention is preferably applied in an intermediate turbine component, i.e. in a component positioned between a high pressure turbine stage and a low pressure turbine stage. It should however be regarded as a non-limiting example application.

The invention is especially directed to a gas turbine engine, and especially to an aircraft engine, comprising the frame. Thus, the invention is especially directed to a jet engine.

Jet engine is meant to include various types of engines, which admit air at relatively low velocity, heat it by combustion and shoot it out at a much higher velocity. Accommodated within the term jet engine are, for example, turbojet engines, turbofan and turboprop engines. The invention will below be described for a turbofan engine, but may of course also be used for other engine types.

A typical frame includes the annular outer structural casing disposed coaxially with the annular inner structural casing, or hub, with a plurality of circumferentially spaced apart hollow struts extending radially therebetween and suitably fixedly joined thereto. The struts are suitably sized to provide a rigid frame for carrying the bearing loads from the hub radially outwardly to the casing.

The struts, however, necessarily pass through the flowpath of the combustion gases and therefore must be specifically sized to minimize undesirable flow blockage thereof. A heat resistant fairing is usually arranged around each strut with an outer profile typically of a symmetrical airfoil shape, which is generally an elongated oval profile with relatively thin leading and trailing edges. The chord axis of the fairing is generally aligned with the centerline axis of the engine or in alignment with the flow direction to present a minimum flow disturbance. The lateral or circumferential sidewalk of the struts are usually relatively long in the axial direction for providing suitable structural rigidity for carrying the required loads between the hub and casing.

The frames also provide a convenient passageway for typical service lines or conduits which carry fluid between the internal and external portions of the engine radially through the gas flowpath. For example, typical service lines include oil supply, damper beating supply, oil drain, scavenge, and sump pressurization or pressure balance air supply. Accordingly, the service lines typically carry pressurized air through the frame struts, fresh oil to the internal bearings typically supported by the frame, and returning scavenge oil back to the oil supply system. The struts may further be adapted for housing instruments, such as electrical and metallic cables for transfer of information concerning measured pressure and/or temperature etc. The servicing requirement usually governs the number of struts required.

U.S. Pat. No. 5,746,574 discloses a strut tube extending between an outer casing and an inner hub in a gas turbine engine. The strut tube is provided far any conventional use, such as carrying therethrough either pressurized air or oil as required in the engine.

It is desirable to achieve a strut for a gas turbine engine frame with an improved ability to carry loads and which creates conditions for a facilitated manufacture.

According to an aspect of the present invention, a strut is provided for being arranged between an annular inner structural casing and an annular outer structural casing, in a gas turbine engine frame for carrying loads between the inner and outer structural casing, during, operation, wherein the strut comprises a first tube, which is configured to house a service line or pipe between the inner and outer structural casing. The strut is characterized in that it comprises a second tube, which is configured to house a fastening element for rigidly connecting the inner and outer structural casing, and that the first and second tube are arranged in a side-by-side relationship and rigidly attached to each other.

The wording “side-by-side relationship” should be interpreted in a wide sense and specifically not limited to that the tubes are in direct contact with each other, but only next to each other and preferably in parallel with each other. Thus, the tubes may be connected to each other via one or several distancing elements.

Such a strut may be clamped between the inner and outer structural casing via the fastening element. The fastening element may be formed by a bolt, which is inserted in the tube from the outside of the outer annular casing and engages in a threaded portion in the inner structural casing. Thus, assembly of the frame in this way is easy.

A gas turbine engine frame with such a clamped strut between the inner and outer structural casing creates conditions for a high stiffness.

Further, the strut itself may be manufactured in an easy way, for example by extrusion or welding sheet metal parts.

According to a preferred embodiment, the first tube has a first extension direction, the second tube has a second extension direction and the first and second extension directions are in parallel with each other. In this way, a compact strut in a direction crosswise to the extension direction of the strut may he achieved. In other words, a compact strut in a circumferential direction of the frame is achieved. Preferably, the second tube extends along a straight line at least along a substantial part of an extension direction of the first tube.

According to a further preferred embodiment, the first and second tubes are interconnected via at least one distance element. This embodiment creates conditions for a facilitated manufacture. Each tube may in a first step be produced individually (for example via sheet forming) so that each of the tubes comprises a projecting flat part along the longitudinal direction of the tube. In a second step, the flat parts are interconnected via for example welding, thereby forming the distance element.

Preferably, said at least one distance element is formed by an elongate wall, which is rigidly attached to the first and second tube at opposite edges along the complete length of the strut in an extension direction of the first tube.

According, to a farther preferred embodiment, the strut comprises a third tube, which is configured to house a fastening element for rigidly connecting the inner and outer structural casing, and the third tube is rigidly attached to the first tube. Thanks to that the strut comprises two tubes, each of which is configured for housing a fastening element, a substantially increased stiffness of the frame may be achieved.

Preferably the third tube has a third extension direction and the third, extension direction lies in a plane defined by the first and second extension direction. In this way, a compact strut in a direction crosswise to the extension direction may be achieved.

Preferably, the third tube has a third extension direction and the second and third extension directions are in parallel with each other.

According to a further development of the last mentioned embodiment, the third tube is arranged on an opposite side of the first tube in relation to the second tube. This design creates conditions for a further improved increased stiffness of the frame. More specifically, it specifically creates conditions for a high trunnion/overturning stiffness but also sufficient radial stiffness and lateral stiffness.

It is also desirable to achieve a gas turbine engine frame with an improved ability to carry loads and which creates conditions for a facilitated manufacture.

According to another aspect of the present invention, a gas turbine engine frame comprises an annular inner structural casing and an annular outer structural casing defining an annular flow passageway therebetween and a plurality of substantially radially extending, circumferentially spaced struts arranged between the casings and configured for carrying loads between the inner and outer structural casing, during operation, characterized in that at least one of the struts is formed by a strut according to any one of the abovementioned designs.

According to another aspect of the present invention, a gas turbine engine comprises an annular inner structural casing and an annular outer structural casing defining an annular flow passageway therebetween and a plurality of substantially radially extending circumferentially spaced struts arranged between the casings and configured for carrying loads between the inner and outer structural casing during operation, characterized in that at least one of the struts is clamped between said annular inner structural casing and said annular outer structural casing. The strut is preferably hollow and a fastening element extends through an internal space of the hollow strut and clamps the strut between said annular inner structural casing and said annular outer structural casing. It should specifically be noted that this gas turbine engine frame is not limited to that the strut is formed by a plurality of tubes.

Other advantageous features and functions of various embodiments of the invention are set forth in the following, description and in the dependent claims.

### BRIEF DESCRIPTION OF THE DRAWINGS

The invention will be explained below, with reference to the embodiment shown on the appended drawings, wherein

FIG. 1 is a schematic side view of an aircraft engine cut along a plane in parallel with the rotational axis of the engine,

FIG. 2 is a perspective view of a compressor intermediate frame in the aircraft engine shown in FIG. 1, FIG. 3 is a perspective and partly cut view along cut A-A of a strut in the compressor intermediate frame from FIG. 2,

FIG. 4 is a perspective and partly cut view along cut B-B of a strut in the compressor intermediate frame from FIG. 2,

FIG. 5 is a partly cut view along cut C-C of a strut in the compressor intermediate frame from FIG. 2,

FIG. 6 is a perspective view of one of the struts in the frame shown in FIG. 2,

FIG. 7 is a cut view along cut D-D of the strut shown in FIG. 6, and

FIG. 8 is a perspective view of a turbine intermediate frame in the aircraft engine shown in FIG. 1.

### DETAILED DESCRIPTION

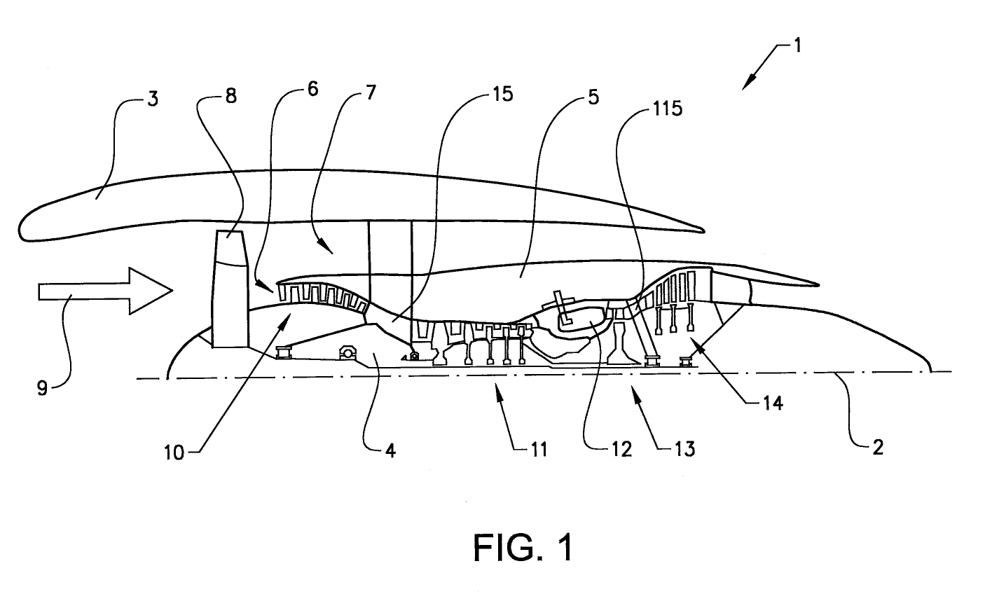

The invention will below be described for a two-shaft turbofan aircraft engine 1, which in FIG. 1 is circumscribed about an engine longitudinal centerline axis 2. The engine 1 comprises an outer casing or nacelle 3, an inner casing 4 (rotor) and an intermediate casing 5 which is concentric to the first two casings and divides the gap between them into an inner primary gas channel 6 for the compression of air and a secondary channel 7 in which the engine bypass air flows. Thus, each of the gas channels 6, 7 is annular in a cross section perpendicular to the engine longitudinal centerline axis 2.

The engine 1 comprises a fan 8 which receives ambient air 9, a booster or low pressure compressor (LPC) 10 and a high pressure compressor (HPC) 11 arranged in the primary gas channel 6, a combustor 12 which mixes fuel with the air pressurized by the high pressure compressor 11 for generating combustion gases which flow downstream through a high pressure turbine (HPT) 13 and a low pressure turbine (LPT) 14 from which the combustion gases are discharged from the engine.

A high pressure shaft joins the high pressure turbine 13 to the high pressure compressor 11. A low pressure shaft joins the low pressure turbine 14 to the low pressure compressor 10. The low pressure shaft is at least in part rotatably disposed co-axially with and radially inwardly of the high pressure rotor.

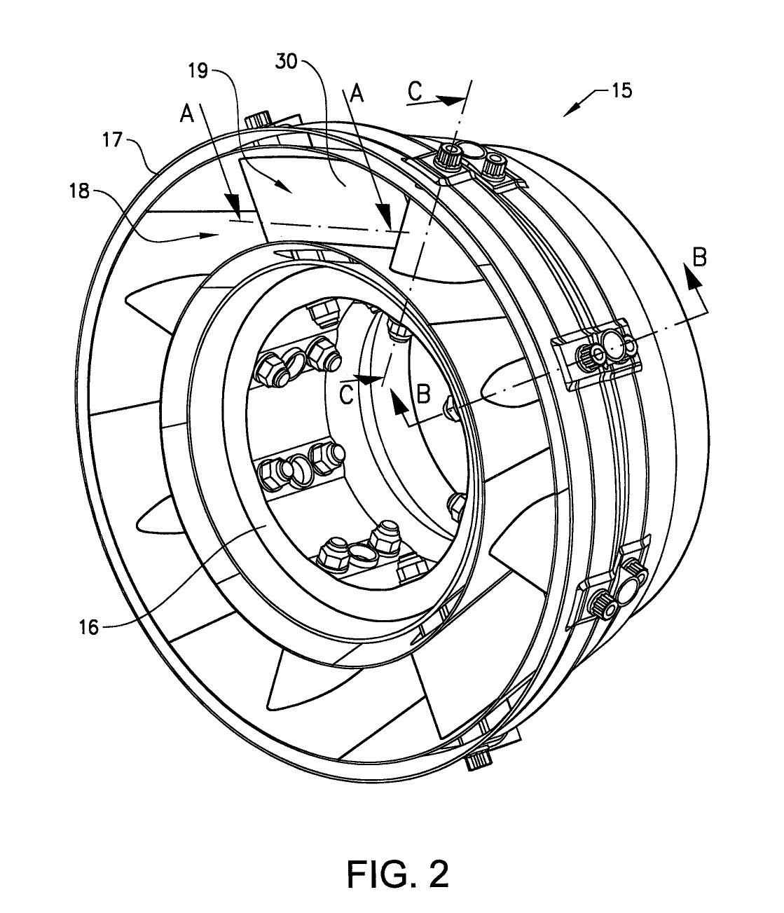

FIG. 2 shows an intermediate compressor frame 15 comprising an annular inner structural casing 16 and an annular outer structural casing 17 defining an annular flow passageway 18 therebetween. The annular inner casing 16 and the annular outer casing 17 are disposed coaxially about the centerline axis 2. The frame 15 further comprises a plurality of substantially radially extending circumferentially spaced struts 19 arranged between the casings 16, 17 and configured for carrying loads between the inner and outer structural casing during operation.

The struts 19 are designed for transmission of loads in the engine. The struts 19 are further hollow for reducing, weight and for providing convenient passages between the outer casing 17 and the inner casing 16 radially inwardly through the flowpath 18 for channeling required service lines or conduits therebetween.

Conventional sources of cooling air and lubrication oil are located outside the casing 17 of the frame 15, with bearings and other components requiring oil or pressurized air being located inside the engine within the hub region near the centerline axis 2. Typical service lines include oil supply, damper bearing supply, oil drain, scavenge, and sump pressurization or pressure balance system air supply. Further, the struts may be designed for housing instruments, such as electrical and metallic cables for transfer of information concerning measured pressure and/or temperature, a drive shaft for a start engine etc. The struts 19 can also be used to conduct a coolant. Accordingly, the required conduits or tubes therefor may be readily routed through individual ones of the struts 19 without further affecting the flowpath 18.

The frame 15 is configured to connect the intermediate casing 5 and the inner casing 4 and is formed by an Intermediate Compressor Case (ICC). The frame 15 is designed for guiding the gas flow from the low pressure compressor section 10 radially inwards toward the high pressure compressor section inlet.

However, the flowpath 18 is a primary aerodynamic component of the engine which is specifically configured for maximizing aerodynamic engine efficiency. Since the struts 19 inherently obstruct a portion of the flowpath 18 between the compressor stages, aerodynamic losses are associated therewith. In order to reduce these losses, the individual struts 19 are limited in size both axially along their chord dimension as well as along their tangential or circumferential thickness dimension.

As shown n FIG. 2, a failing 30 is positioned around each of the struts 19. The fairing 30, which surrounds said strut 19 is configured for minimizing flow blockage and/or for protecting the strut 19 from the gases which flow through the passageway 18 during operation. The fairing 30 preferably has an aerodynamically thin and smooth outer profile or configuration which is flattened in the circumferential direction so that the fairing 30 is substantially smaller in circumferential thickness than in axial chord length. In this way, flow blockage is minimized.

However, the conventional design of lubrication and secondary air systems in the engine require certain minimum internal passage size of the service lines for reducing pressure losses therein. Since the service lines extend through the struts 19, the conflicting design requirements thereof increase the design complexity of providing suitably sized and configured service lines through the narrow struts 19.

The plurality of circumferentially spaced struts 19 are rigidly connected to both the inner ring 16 and to the outer ring 17 forming a load-carrying structure. Although not explicitly shown in FIG. 2, the fairing 30 surrounding the strut 19 has an airfoil shape with a rounded leading edge facing the incoming gas flow.

FIG. 3 is a perspective and partly cut view along cut A-A of one of the struts 19 in the frame 15 from FIG. 2. The strut 19 comprises a first tube 20, which is configured to house a service line or pipe 21 between the inner and outer structural casing 16, 17. The strut 19 comprises a second tube 22, which is configured to house a fastening element 23 for rigidly connecting the inner and outer structural casing. The first and second tubes 20, 22 are arranged in a side-by-side relationship and rigidly attached to each other.

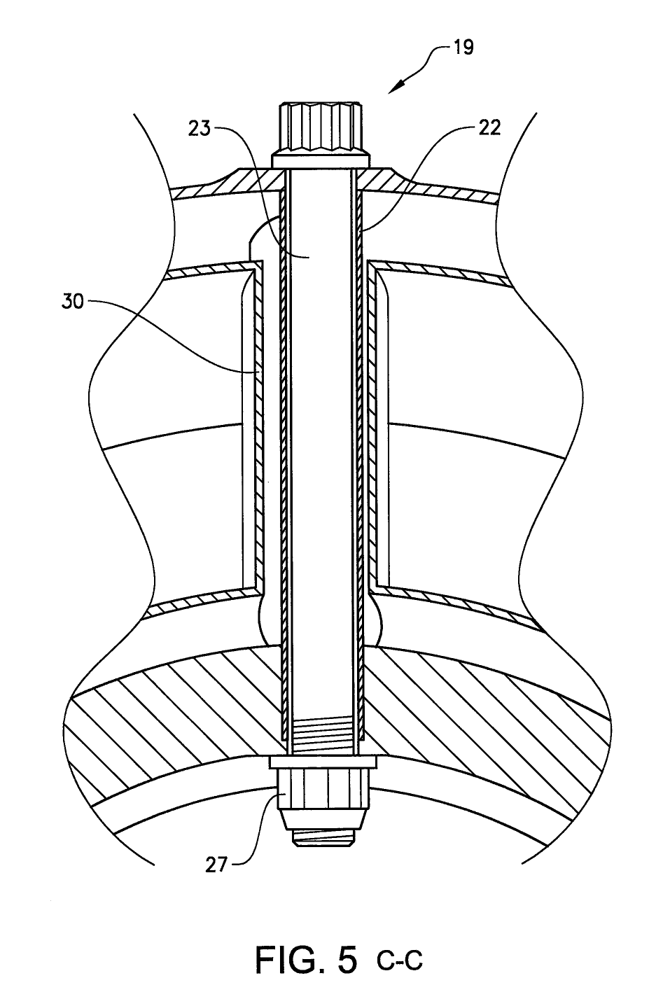

The first tube 20 has a first extension direction. The second tube 22 has a second extension direction and the first and second extension directions are in parallel with each other, see also FIG. 6. The first tube 20 extends along a straight line at least along a substantial part of an extension direction of the first tube. Referring to the frame 15 shown in FIG. 2, the first extension direction is o a radial direction of the frame.

The first and second tubes 20, 22 are interconnected via, at least one distance element 24. The distance element 24 is formed by an elongate wall, which is rigidly attached to the first and second tubes 20, 22 at opposite edges along the complete length of the strut 19 in an extension direction of the first tube.

The strut 19 comprises a third tube 25, which is configured to house a fastening element 26 for rigidly connecting the inner and outer structural casing 16, 17. The third tube 25 is rigidly attached to the first tube 20 The third tube 25 has a third extension direction which lies in a plane defined by the first and second extension directions, see also FIG. 6. The third tube 25 has a third extension direction and the first and third extension directions are in parallel with each other. Further, the third tube 25 is arranged on an opposite side of the first tube 20 in relation to the second tube 22. Thus, the first, second and third extension directions are straight and in parallel with each other.

At least one of said tubes 20, 22, 25 has a constant cross sectional shape at least along a substantial portion of an extension direction of the tube. In the shown embodiment, each of the tubes 20, 22, 25 has a constant cross sectional shape along the complete length of the tube. Thus, the strut 19 has a constant cross sectional shape at least along a substantial portion of an extension direction of said first tube. More specifically, the strut 19 has a constant cross sectional shape along the complete length of the strut 19. The term “constant” means that a cross section of is the same with regard to shape and dimension in two different positions in an extension direction of the tube/strut.

At least one of said tubes 20, 22, 25 is circular in cross section. In the shown embodiment, each of the three tubes 20, 22, 25 is circular in cross section.

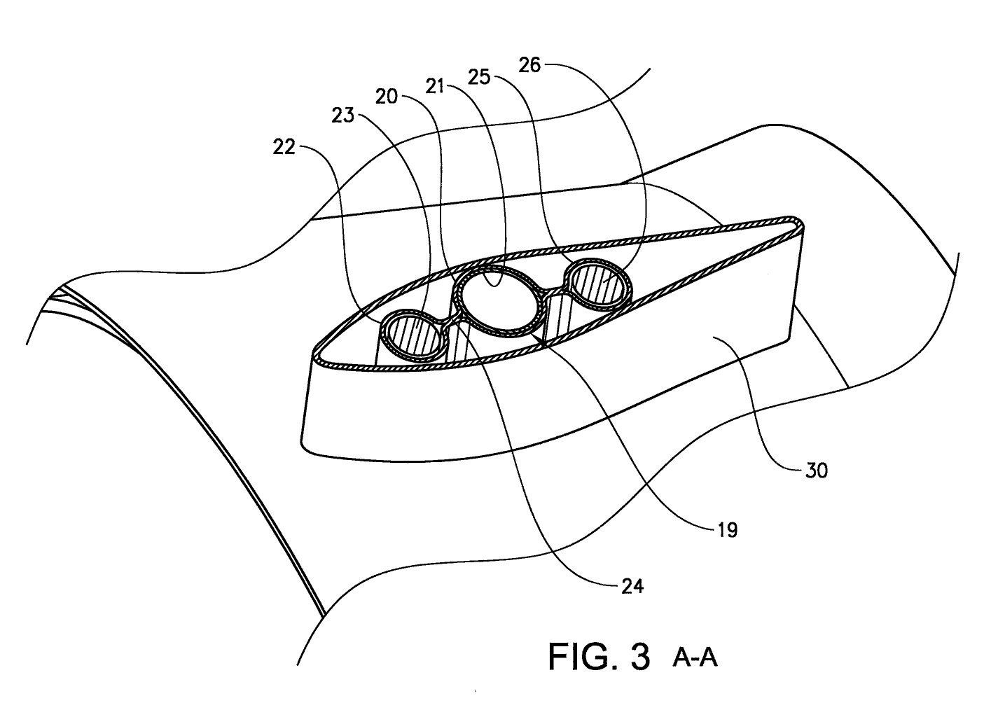

FIG. 4 is a perspective and partly cut view along cut B-B of one of the struts 19 in the frame 15 from FIG. 2. More specifically, a fastening arrangement of the strut 19 is shown. A first fastening element 23 is positioned in the second tube 22 and rigidly connects said annular inner structural casing 16 and said annular outer structural casing 17 by clamping the strut 19 between said annular inner structural casing 6 and said annular outer structural casing 17. Further, a second fastening element 26 is positioned in the third tube 25 and rigidly connects said annular inner structural casing 16 and said annular outer structural casing 17 by clamping the strut 19 between said annular inner structural casing 16 and said annular outer structural casing 17.

For ease of manufacturing, each of the fastening elements 23, 26 has an outer dimension (diameter), which is somewhat smaller than an internal dimension (diameter) of the respective tube.

Each of the first and second fastening elements 23, 26 is formed by a bolt, which is inserted in the respective time 22, 25 from the outside of the outer annular casing 17 and engages in a respective threaded portion 27. 28 at the inner structural casing 16. Said threaded portion may be formed by a nut. Said nut may be rigidly connected to the inner casing 16.

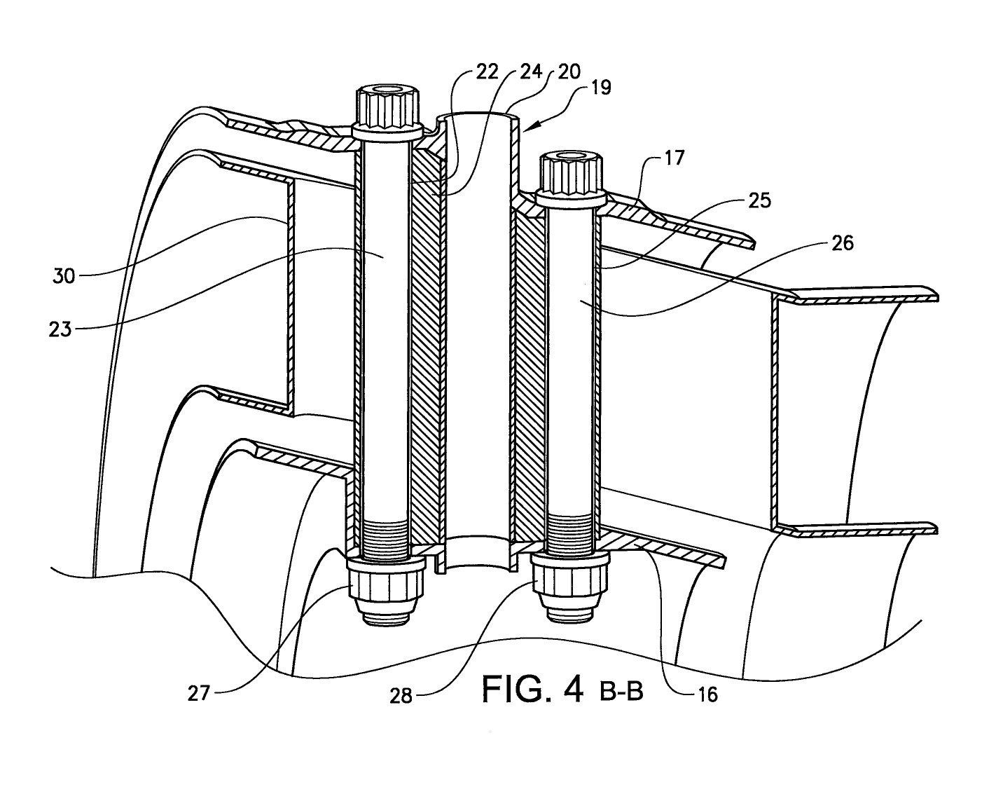

FIG. 5 is a partly cut view along cut C-C of a strut 19 in the frame 15 from FIG. 2.

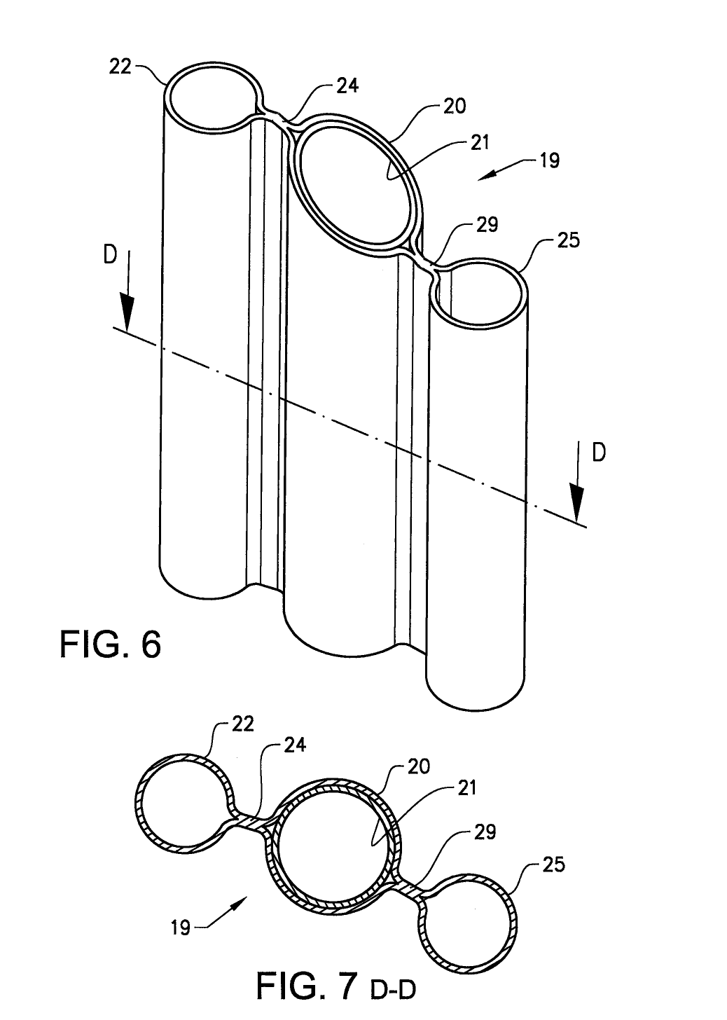

FIG. 6 is a perspective view of one of the struts 19 in the frame 15 shown in FIG. 2 and FIG. 7 is a cut view along cut D-D of the strut 19 shown in FIG. 6. The first and third tubes 20, 25 are interconnected via at least one distance element 29. The distance element 29 is formed by an elongate wall, which is rigidly attached to the first and third tubes 20, 25 at opposite edges along, the complete length of the strut 19 in an extension direction of the first tube 20.

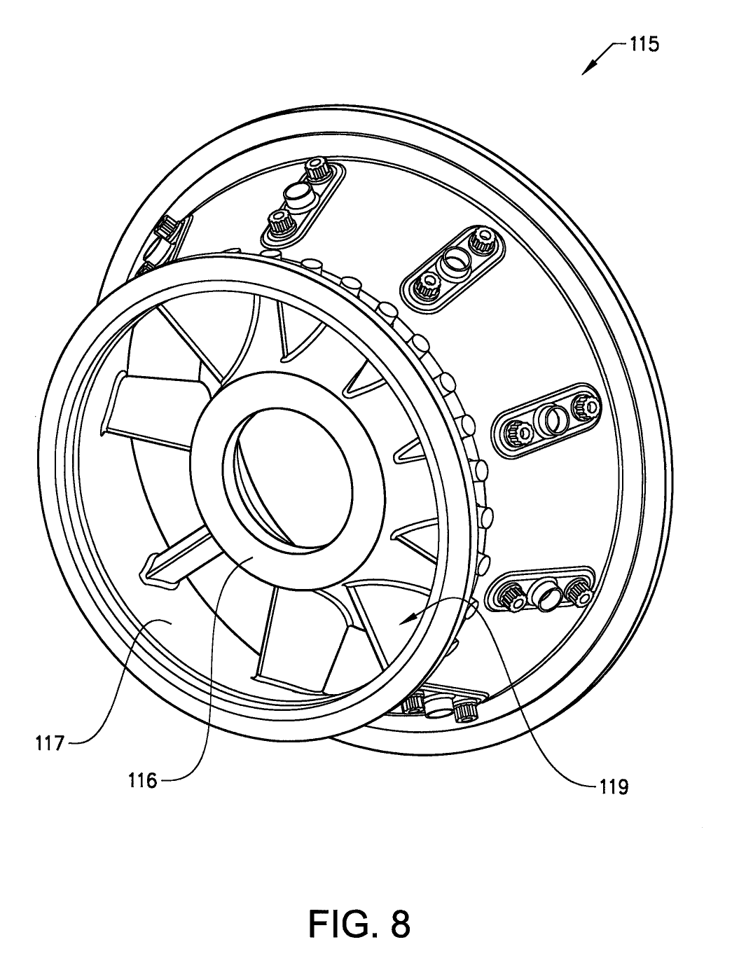

FIG. 8 shows an intermediate turbine frame 115 comprising an annular inner structural casing 116 and an annular outer structural casing 117 defining an annular flow passageway therebetween. The annular inner casing 116 and the annular outer casing 117 are disposed coaxially about a centerline axis. The frame 115 further comprises a plurality of substantially radially extending circumferentially spaced struts 119 arranged between the casings 116, 117 and configured for carrying loads between the inner and outer structural casing during operation. The configuration and arrangement of the struts 119 is the same as has been described above and shown in FIGS. 2-7 for the intermediate compressor frame.

The invention is not in any way limited to the above described embodiments, instead a number of alternatives and modifications are possible without departing from the scope of the following claims.

The invention is of course not limited to application in a two-shaft engine, but may very well be applied in other engine types, such as a three shaft engine.

The invention is not limited to application in an intermediate structure but may for example be applied in a compressor rear structure or turbine rear structure.

According to an alternative to that the strut is formed by rigidly connecting separate pieces (one piece comprising a single tube), the strut may be formed by a one-piece unit or two halves, each comprising a plurality of interconnecting half-tubes.

According to an alternative to that said tubes are circular in cross section, at least one of the tubes (preferably the first tube for housing a service line) may have a non-rotationally symmetrical cross section, such as an oval or rectangular shape.

According to an alternative to that the fastening element is formed by a bolt, it may be formed by other types of elongated means adapted to clamp the strut between the two casings.

According to an alternative or complement to that the fastening element extends through the strut, the strut may be directly attached to the casing(s) by means of welding or other joining method.

According to an alternative to that the strut comprises a plurality of separate holes (one from each rube) extending in the longitudinal direction of the strut, the interior of the tubes may be in communication with each other. More specifically, the tubes may be in communication with each other via a passage along the complete length of the strut.

1. A strut (19) for being arranged between an annular inner structural casing (16) and an annular outer structural casing (17) in a gas turbine engine frame (15) for carrying loads between the inner and outer structural casing (16,17) during operation, wherein the strut (19) comprises a first tube (20), which is configured to house a service line or pipe (21) between the inner and outer structural casing (16,17) characterized in that the strut (19) comprises a second tube (22), which is configured to house a fastening element (23) for rigidly connecting the inner and outer structural casing (16,17) and that the first and second tube (20,22) are arranged in a side-by-side relationship and rigidly attached to each other.

2. A strut according to claim 1, characterized in that the first tube (20) has a first extension direction, that the second tube (22) has a second extension direction and that the first and second extension direction are in parallel with each other.

3. A strut according to claim 1 or 2, characterized in that the first tube (20) extends along a straight line at least along a substantial part of an extension direction of the first tube.

4. A strut according any preceding claim, characterized in that the first and second tubes (20,22) are interconnected via at least one distance element (24).

5. A strut according to claim 4, characterized in that said at least one distance element (24) is formed by an elongate wall, which is rigidly attached to the first and second tubes (20,22) at opposite edges along the complete length of the strut (19) in an extension direction of the first tube (20).

6. A strut according to any preceding claim, characterized in that the strut (19) comprises a third tube (25), which is configured to house a fastening element (26) for rigidly connecting the inner and outer structural casings (16,17), and that the third tube (25) is rigidly attached to the first tube (20).

7. A strut according to claims 2 and 6, characterized in that the third tube (25) has a third extension direction and that the third extension direction lies in a plane defined by the first and second extension direction.

8. A strut according to claim 2 and 6 or 7, characterized in that the third tube (25) has a third extension direction and that the first and third extension direction are in parallel with each other.

9. A strut according to any one of claims 6-8, characterized in that the third tube (25) is arranged on an opposite side of the first tube (20) in relation to the second tube (22).

10. A strut according to any preceding claim, characterized in that at least one of said tubes (20,22,25) has a constant cross sectional shape at least along a substantial portion of an extension direction of the tube.

11. A strut according to any preceding claim, characterized in that the strut (19) has a constant cross sectional shape at least along a substantial portion of an extension direction of said first tube (20).

12. A strut according to any preceding claim, characterized in that at least one of said tubes (20,22,25) is circular in cross section.

13. A gas turbine engine frame (15) comprising an annular inner structural casing (16) and an annular outer structural casing (17) defining an annular flow passageway therebetween and a plurality of substantially radially extending circumferentially spaced struts (19) arranged between the casings and configured for carrying loads between the inner and outer structural casing during operation, characterized in that at least one of the struts (19) is formed by a strut according to any preceding claim.

14. A gas turbine engine frame according to claim 13, characterized in that the frame (15) comprises a first fastening element (23), which is positioned in the second tube (22) and rigidly connects said annular inner structural casing (16) and said annular outer structural casing (17) by clamping the strut (19) between said annular inner structural casing and said annular outer structural casing.

15. A gas turbine engine frame according to claim 16, characterized in that the frame comprises a strut (19) according to any one of claims 6-9 and a second fastening element (26), which is positioned in the third tube (25) and rigidly connects said annular inner structural casing (16) and said annular outer structural casing (17) by clamping the strut (19) between said annular inner structural casing and said annular outer structural casing.

16. A gas turbine engine frame according to any one of claims 13-15, characterized in that the frame (15) comprises at least one fairing (30), which surrounds said strut (19) and is configured for minimizing flow blockage and/or for protecting the strut from the gases which flow through the passageway during operation.

17. A gas turbine engine frame (15) comprising an annular inner structural casing (16) and an annular outer structural casing (17) defining an annular flow passageway therebetween and a plurality of substantially radially extending circumferentially spaced struts (19) arranged between the casings and configured for carrying loads between the inner and outer structural casing during operation, characterized in that at least one of the struts (19) is clamped between said annular inner structural casing and said annular outer structural casing.

18. A gas turbine engine (1) characterized in that it comprises a gas turbine engine frame (15) according to any one of claims 13-17.
